(19) United States
(12) Patent Application Publication
(10) Pub. No.: US 2006/0018816 A1
(43) Pub. Date: Jan. 26, 2006

(54) Diluted magnetic semiconducting ZnO single crystal

(75) Inventors: Jeff Nause, Mableton, GA (US); Varatharajan Rengarajan, Atlanta, GA (US); William Michael Nemeth, Atlanta, GA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Cermet, Inc.

(21) Appl. No.: 11/061,161

(22) Filed: Feb. 18, 2005

Related U.S. Application Data
(60) Provisional application No. 60/546,148, filed on Feb. 20, 2004.

(51) Int. Cl. C01G 9/02; C01B 33/00

(52) U.S. Cl. 423/324

(57) ABSTRACT

A new diluted magnetic semiconductor-spintronics material and method for its production are disclosed. The material can be in bulk or thin film form. The material comprises zinc oxide (ZnO) which includes a transition element or a rare earth lanthanide, or both, in an amount sufficient to change the material from non-magnetic state to room temperature ferromagnetic state. The bulk crystal is grown by high pressure melt technique. A new method for growing transition metal doped ZnO thin films is presented. A metalorganic chemical vapor deposition (MOCVD) technique is used to grow thin films of transition metal doped ZnO and organic compounds have been used as source materials.

### BACKGROUND OF THE INVENTION

Spin Electronics or ‘spintronics’ exploits both spin and charge of the electrons. The ability to exploit the spin degree of freedom in semiconductors promises new devices with enhanced functionality, higher speeds and reduced power consumption. Diluted Magnetic Semiconductors (DMS) are semiconductors in which transition metal ions or rare earth lanthanides substitute cations of host semiconductor materials. Localized d electrons of the doping metals strongly couple with the extended sp carriers of the host semiconductors, a sp-d or sp-f exchange interaction which induces intriguing magneto-optical and magneto-electrical properties. The polarization of the light can be controlled by adjusting the spin direction of the DMS.

S. J. Pearton et al have made an extensive discussion on spintronic materials and their applications.

K. Sato et al made theoretical calculations based on LDA method on the mechanism of transition metals in ZnO. They predicted ZnO doped with V, Cr, Fe, Co and Ni will yield ferromagnetism while p-type ZnO doped with Mn will yield ferromagnetism.

K. Ueda et al deposited transition metal doped ZnO thin films by Pulsed Laser deposition and measured the magnetic properties. According to Ueda et al Cobalt doped with a concentration of 25% showed ferromagnetic Curie temperature at 280 K.

Cho et al investigated effect of thermal annealing on the magnetic properties of ZnCoFeO thin films grown by reactive magnetron sputtering and found that spontaneous magnetization increase with rapid thermal annealing.

K. Sato et al investigated the ferromagnetism in ZnO based diluted magnetic semiconductors based on the first principle calculations and reported that ferromagnetic state is more stable than the spin glass state in V, Cr, Fe, Co and Ni doped ZnO without any additional carrier concentration.

Vanadium doped ZnO with vanadium concentrations varying from 5 to 15% have been grown by Pulsed Laser Deposition by H. Saeki et al and found room temperature ferromagnetism at 300 K for Zn_{0.85}V_{0.15}O.

Pulsed Lased Deposition technique was exploited to grow Ni doped ZnO thin films with Ni concentration up to 25 at % by Wakanao et al. Lattice constant increase increased up to 5% and then dropped after that. Ferromagnetism was confirmed at 2 K for Ni concentration 3 to 25% and between 30 and 300 K super paramagnetic behavior has been observed.

Tiwari et al achived Mn doped ZnO thin films with Mn composition up to 25 at % by pulsed laser deposition method and analyzed structural and optical properties

P. Sharma et al reported ferromagnetism at 425 K for Zn_{0.978}Mn_{0.022}O with a Mn concentration of 2.2% grown by pulsed laser deposition.

Kim et al investigated magnetoresistive properties of laser deposited Zn₁₋ₓCoₓO (x=0.02-0.25) doped with Al

Qiu et al reported growth of Ni doped ZnO films on Si by reactive electron beam sputtering method and characterized the films.

Epitaxial ZnO films Co-doped with transition metals and Al were grown by pulsed laser deposition by Jin et al and studied the Magnetoresistance properties.

A review for the recent progress of research in the field of oxide based diluted magnetic semiconductors is given by Fukumura et al.

Kim et al have grown Mn doped ZnO thin films by Sol-Gel method with Mn concentrations varying between 0.1 and 0.3 and measured magnetic properties. Also reported Curie temperature of 39 K for the film with Mn concentration 20 at %.

Kim et al reported Mn doped ZnO ceramics with Mn concentration up to 25 at % prepared by solid state reaction and measured the electrical properties. ZnMnO films showed paramagnetic behavior.

Polyakov et al reported properties of Co and Mn implanted ZnO single crystals.

Lim et al reported growth of Co doped ZnO films by rf magnetron sputtering method with Co concentration up to 40 at %. AGM measurements confirmed that films with 20% and above Co concentration exhibit ferromagnetism.

Mn and Co atoms were implanted on Sn doped ZnO single crystals by N. A. Theodoropoulou and the ferromagnetic Curie temperature were reported at room temperature. The implanted concentrations were 3-5 at %. Also they confirmed that Co implantation lead to precipitation.

Jin et al used combinatorial laser MBE method to fabricate transition metal doped ZnO films. The solubility limits of the dopant metals have been discussed.

Mn and Co doped ZnO bicrystals were grown by N. Ohashi et al through flux growth technique and reported the I-V characteristics of the bicrystals.

Dietl et al reported room temperature ferromagnetism in ZnO by theoretical predictions based on Zener Model.

Fe incorporated ZnO thin films were grown by Ming Zhang et al rf magnetron sputtering on Si substrate.

Satoh et al reported growth of Cr doped ZnO thin films by pulsed laser deposition method and fabricated p-i-n structures.

Sato and Yoshida found out based on ab initio calculations that 3d transition metal atoms of V, Cr, Fe, Co and Ni show ferromagnetic ordering of their magnetic moments in ZnO without any additional carrier doping treatments.

Combinatorial laser MBE method was employed by Jin et al to grown transition metal doped ZnO thin films and investigated the solubility behavior of the dopants. They have also reported that Mn and Co have higher solubility.

Kim et al fabricated Zn_{0.75}Co_{0.25}O thin films on sapphire by pulsed laser deposition method and investigated structural and magnetic properties. Also reported that origin of ferromagnetism is due to Co clusters.

Jung et al have grown Zn₁₋ₓMnₓO (x=0.1 and 0.3) thin films on sapphire by laser molecular beam epitaxy and found the ferromagnetism at 30 and 45 K. Coercive field for Zn_{0.9}Mn_{0.1}O has also been reported.

Fukumura et al reported growth of Mn doped ZnO by pulsed laser deposition with Mn concentration varying from 0 to 35% and studied the electrical properties.

Fukumura et al used pulsed laser deposition method to grow ZnMnO thin films and measured magnetoresisitive properties.

Pulsed Laser Deposition method was used to deposit Co doped ZnO thin films by Ando et al. The magneto optical properties were investigated. Faraday rotation was also been studied.

Fukumura et al deposited Zn_{0.64}Mn_{0.36}O film with a thickness of 2.3 μm on sapphire substrate by pulsed laser deposition substrate and studies the magnetic properties. The results show spin glass behaviors and strong antiferromagnetism.

### SUMMARY OF THE INVENTION

The remarkable developments currently being made in the fields of electronics and information technologies have been made possible by exploiting the properties of electron spin and charge. Integrated circuits used for data processing use the charge of electrons in semiconductors, while data storage media such as hard disks use the spin of electrons in magnetic material. Spin Electronics or ‘spintronics’ exploits both spin and charge of the electrons. This spin of the electron has attracted renewed interest because it promises a wide variety of new devices that combine logic, storage and sensor applications. The ability to exploit the spin degree of freedom in semiconductors promises new devices with enhanced functionality, higher speeds and reduced power consumption. This invention relates to a diluted magnetic semiconductor materials or compounds for electronics and opto-electronics devices. These diluted magnetic semiconductor materials include zinc oxide doped with 3d transition and rare earth lanthanides bulk single crystals with low defect density.

In one embodiment, the invention is directed to an article of manufacture comprising a room temperature spintronic material based on doped zinc oxide (ZnO) in bulk form. In another embodiment, a method of the invention is directed to growing a spintronic material as doped ZnO in thin film form. The spintronic material can be grown using metalorganic chemical vapor deposition (MOCVD) with a dopant incorporated in the ZnO material. The dopant can be a 3d transition metal, a rare earth lanthanide, or both. The concentration of the dopant is more than 0 but less than 40 at %.

The doped crystal and thin film in accordance with the invention showed room temperature ferromagnetism. The lowest transition metal concentration which showed room temperature ferromagnetism was 0.035%. The present invention resulted in a room temperature spintronics material based on transition metal and lanthanide doped ZnO. The present invention resulted in a room temperature Curie temperature diluted magnetic semiconductor-spintronics single crystal in both bulk and thin film form.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram of the modified high pressure Bridgeman growth apparatus.

FIG. 2 is a schematic diagram of the MOCVD system.

FIG. 3 is a graph of magnetic field vs. magnetization of Zn_{0.99}Mn_{0.01}O at 10 K.

FIG. 4 is a graph of magnetic field vs. magnetization of Zn_{0.99}Mn_{0.01}O at 100 K.

FIG. 5 is a graph of magnetic field vs. magnetization of Zn_{0.99}Mn_{0.01}O at 300 K.

FIG. 6 is a graph of magnetic field vs. magnetization of Zn_{0.99}Co_{0.01}O at 300 K.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

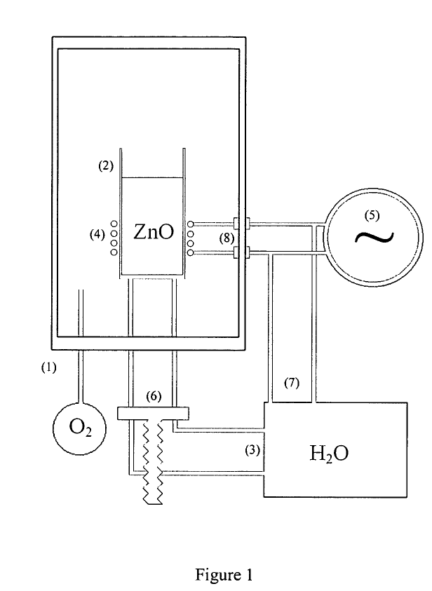

The crystal growth apparatus, seen in FIG. 1, utilizes a modified Bridgeman growth technique including a pressure vessel that contains pressurized oxygen (1). The apparatus also includes a cooling unit (2) that is situated in the pressure vessel. The cooling unit receives a coolant flow from outside of the vessel (3) and has cooled surfaces that define an enclosure, which receives the ZnO with proper dopant concentration (10¹⁵-10²⁰ atoms/cc).

The apparatus further includes an inductive heating element (4) situated in the vessel, which is coupled to receive rf power externally to the vessel (5). The element heats the interior portion of the doped ZnO to form a molten interior portion contained by a relatively cool, exterior solid-phase portion of the doped ZnO that is closer relative to the molten interior, to the cooled surfaces of the cooling unit. Due to the pressure exerted by the gas contained in the vessel, the liquid interior of the doped ZnO becomes congruently melting to prevent its decomposition. The cooling unit is then lowered (6) through the element to produce crystal nucleation at the base of the cooling unit and preferential crystal growth through the distance traveled.

In addition to rf power, the heating element receives a coolant flow (7) from a feedthrough that extends through a wall of the pressure vessel. In proximity to the vessel wall, the feedthrough has two coaxial conductors (8) to improve the electric power transfer to the heating element and to reduce heating of the external surfaces of the vessel. The two conductors of the feedthrough are cylindrical in shape, and define two channels for channeling a coolant flow to and from, respectively, the heating element.

The present invention presents a method of growing transition metal doped ZnO by metalorganic chemical vapor deposition. The transition metals include Mn, Co, V, Ni, Fe, Sc. These materials can be formulated as follows.

Zn₁₋ₓTMₓO where TM may be Mn, Co, Ni, Fe, V, Sc and X varies between 0 and 40%.

The substrates used in this invention are ZnO, Sapphire, Quartz, Si. The organic precursors are kept in separate bubblers. In the present invention, a reaction gas comprising a first gaseous organometallic material containing an organozinc compound and a second dopant gas are supplied to the surface of the heated surface by flowing an inert carrier gas through the first and second gases. A third gaseous material containing oxygen is also supplied to the surface of a heated substrate. The transition metal doped ZnO compound semiconductor spintronic thin film grows on the heated substrate surface through the reaction of the first, second and third gaseous materials. Examples of the source materials used are Zinc acetylacetonate, Diethyl Zinc, Manganese Acetylacetonate, Cobalt acetylacetonate, Iron acetylacetonate, Vanadium Acetylacetonate, Nickel acetylacetonate and scandium acetyl acetonate. The temperatures of the bubblers varied between 50 and 200° C. to get organic precursors in vapor phase. Argon is used as a carrier gas.

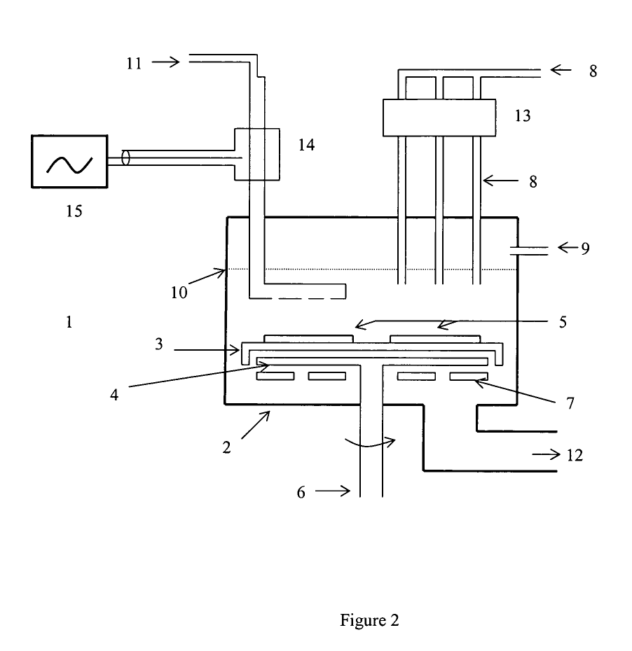

FIG. 2 schematically shows an apparatus 1 suitably used to carry out the method of the present invention.

As shown in FIG. 1, the apparatus 1 has a reaction chamber 2 made of, for example, stainless steel.

A susceptor 3 is arranged in the chamber 2 to place a substrate 5 thereon substantially horizontally. The substrate 5 is loaded/unloaded through a load/unload port, not shown, arranged in the chamber 2, as is well known in the art. The susceptor 3 is a round column having a diameter of, for example, 30 to 100 mm and a height of, for example, 10 to 30 mm. The susceptor 3 is made of a high heat-resistant material which does not contaminate the gases in the chamber 2 upon heating. Such a material includes carbon surface-coated with silicon carbide.

A shaft 6 is fixed to the center of the lower surface of the susceptor 3, and air-tightly extends outside the chamber 2. The shaft 6 can be rotated by any suitable rotating means, not shown, to rotate the susceptor 3, and hence the substrate 5, during the growth operation.

A heater 7 is arranged to heat the susceptor 3, and hence the substrate 5, to a temperature suitable to grow a desired doped ZnO compound semiconductor crystal layer on the substrate, e.g., about 600° C. or more. In FIG. 1, such a heater 7 is provided close to, but away from, the lower surface of the susceptor 3. The heater 7 is controlled to heat the susceptor 3 to the required temperature by a temperature sensor (not shown) incorporated in the susceptor 3, and ON/OFF control or supply current control, not shown.

A first cylindrical blow tube 11 is air-tightly inserted into the chamber 2 parallel or slightly obliquely to the surface of the substrate 5, and extends near the substrate 5. The reaction gas is blown through the first blow tube 11 parallel or slightly obliquely to the substrate surface, together with a carrier gas such as argon gas. The reaction gas is preferably blown substantially parallel to the surface of the substrate 5. The inner diameter of the first blow tube is usually about 20 mm to 100 mm. Preferably, the flow velocity of the reaction gas is high, and is usually 0.01 m/sec or more, preferably 0.2 m/sec to 1 m/sec.

At the lower portion of the chamber 2, an exhaust tube 12 may be provided, if desired, through which the gases inside the chamber 2 may be exhausted by means of an exhaust pump, not shown.

In operation, a substrate 5 such as zinc oxide substrate is placed on the susceptor 3. The susceptor 3 is heated with the heater 7 to a temperature of, for example, 400 to 600° C. to heat the substrate 5 to that temperature. The susceptor 3, and hence the substrate 5, is rotated by driving the shaft 6. The reaction gases are supplied in the chamber 2 through the first blow tube 11 in a direction parallel to the substrate 40. The reactants of the reaction gas react with each other to grow the desired ZnO-based II-VI Group compound semiconductor crystal layer on the entire substrate surface. The growth operation is conducted at atmospheric pressure or a lower pressure.

### EXAMPLE

Mn doped ZnO films were grown on ZnO substrates by the following steps.
1. Chemically cleaned, n-type ZnO single crystal substrates were placed on the substrate carrier plate. This was then loaded onto the reactor susceptor and the chamber sealed.
2. The chamber was evacuated using the exhaust pump to less than 0.1 torr pressure.
3. A flow of 1800 sccm argon and 400 sccm oxygen was introduced into the chamber and the chamber pressure regulated to 10 torr.
4. Meanwhile, the substrate susceptor temperature was increased to 400 degree C. and rotation rate increased to 600 rpm in a period of 30 minutes.
5. This state was maintained a period of time until the temperature of the susceptor stabilized.
6. Diethylzinc vapor was introduced into the chamber entrained in an argon flow of 1160 sccm.
7. Meanwhile, Manganese acetylacetonate vapor was introduced into the chamber in an argon flow of 1160 sccm.
8. Meanwhile, the previous 1800 sccm argon and 400 sccm oxygen flows mentioned were maintained, and the chamber pressure was regulated at 10 torr.
9. This state was maintained for 90 minutes during growth of the films.
10. Subsequently, all gas flows were halted except for 1800 sccm argon and 400 sccm oxygen. The chamber pressure was maintained at 10 torr.
11. The state of the system was maintained for 30 minutes while the substrates cooled to near room temperature.
12. All gas flows were halted, and the chamber was evacuated using the exhaust pump to less than 0.1 torr.
13. The chamber was then vented with atmosphere, and the substrates were removed.

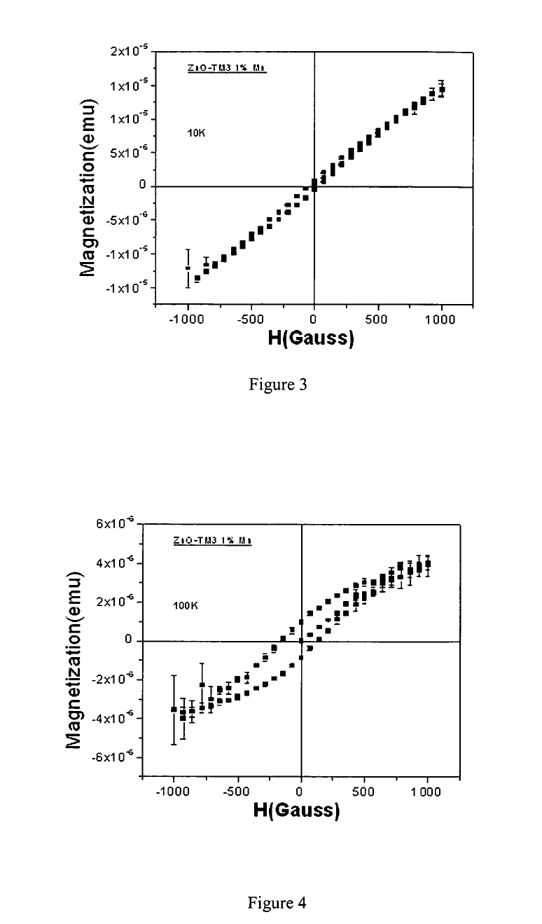

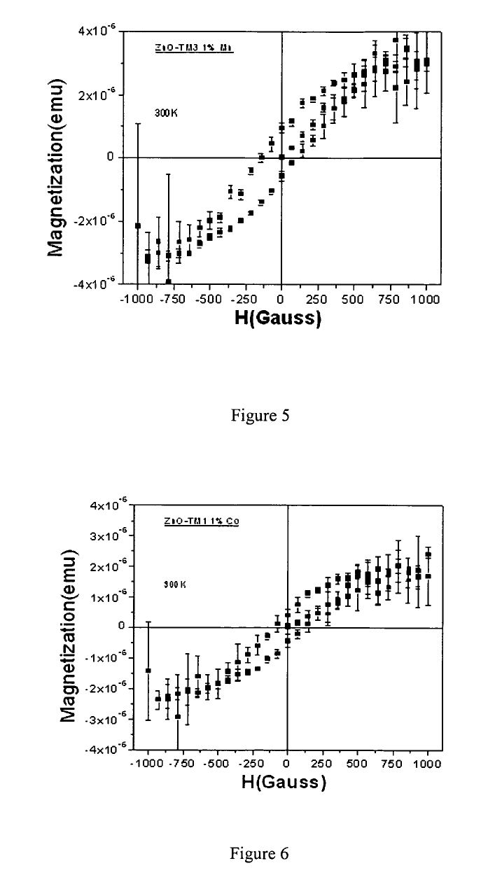

FIGS. 3, 4, 5 and 6 show graphs of magnetic field vs. magnetization of Zn_{0.99}Mn_{0.01}O and Zn_{0.99}Co_{0.01}O at 10, 100, 300 and 300 K respectively. As clear from the figures, the transition metal doped ZnO showed room temperature ferromagnetic Curie temperature.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

### APPENDIX

K. Ando, H. saito, Z. Jin, T. Fukumura, M. Kawaski, Y. Matsumoto and H. Koinuma, “Large magneto-optical effect in an oxide diluted magnetic semiconductor Zn₁₋ₓCoₓO”, Applied Physics Letters, Vol, 78, (2001) 2700-2702

Y. M. Cho, W. K. Choo, H. Kim, D. Kim, Y. Ihm, “Effects of rapid thermal annealing on the ferromagnetic properties of sputtered Zn₁₋ₓ(Co_{0.5}Fe_{0.5})ₓO thin films”, Applied Physics Letters, Vol. 80 (2002) 3358-3360

T. Dietl, H. Ohono, F. Matsukura, J. Cibert and D. Ferrand, “Zener model description of ferromagnetism in zinc blende magnetic semiconductors”, Science, Vol. 287 (2000) 1019-1022

T. Fukumura, Z. Jin, A. Ohtomo, H. Koinuma and M. kawaski, “An oxide diluted magnetic semiconductor: Mn doped ZnO”, Applied Physics Letters, Vol. 75 (1999) 3366-3368

T. Fukumura, Z. Jin, A. Ohtomo, H. Koinuma and M. kawaski,“ZnMnO as a novel diluted magnetic semiconductor”, Proceedings of the 3^{rd} symposium on atomic scale surface and interface dynamics, Mar. 4-5 1999, Fukuoka 161-164

T. Fukumura, Z. Jin, M. kawaski, T. Shono, T. Hasegawa, S. Koshihara, H. Koinuma, “Magnetic properties of Mn doped ZnO”, Applied Physics Letters, Vol. 78 (2002) 958-960

T. Fukumura, Y. Yamada, H. Toyosaki, T. Hasegawa, H. Koinuma and M. kawaski, “Exploration of oxide based diluted magnetic semiconductors toward transparent semiconductors”, Applied Surface Science (In press)

Z. Jin, M. Murakami, T. Fukumura, Y. Matsumoto, A. Ohtomo, M. Kawasaki, H. Koinuma, “Combinatorial laser MBE synthesis of 3d ion doped epitaxial ZnO thin films”, Journal of Crystal Growth, Vol. 214/215 (2000) 55-58

Z. Jin, T. Fukumura, M. Kawasaki, K. Ando, H. saito, T. Sekiguchi, Y. Z. Yoo, M. Murakami, Y. Matsumoto, T. Hasegawa and H. Koinuma, “High throughput fabrication of transition metal doped epitaxial ZnO films: A series of oxide diluted magnetic semiconductors and their properties”, Applied Physics Letters Vol. 78 (2001) 3824-3826

Z. Jin, K. Hasegawa, T. Fukumura, Y. Z. Yoo, T. Hasegawa, H. Koinuma, M. Kawasaki, “Magnetoresistance of 3d transition—metal doped epitaxial ZnO thin films”, Physica E Vol 10 (2001) 256-259

S. W. Jung, S. J. An and G. C. Yi, “Ferromagnetic properties of Zn₁₋ₓMnₓO epitaxial thin films”, Applied Physics Letters, Vol. 80 (2002) 4561-4563

J. H. Kim, J. B. Lee, H. Kim, W. Choo, Y. Ihm and D. Kim, “Electrical magnetic properties of Mn doped ZnO”, Ferroelectrics, Vol. 273 (2002) 71-76

J. H. Kim, H. Kim, D. Kim , Y. Ihm and W. K. Choo, “Magnetoresistance in laser deposited Zn₁₋ₓCoₓO”, Physica B (2003) 304-306

J. H. Kim, H. Kim, D. Kim , Y. Ihm and W. K. Choo, “The origin of room temperature ferromagnetism in cobalt doped Zinc oxide thin films fabricated by PLD”, Journal of European Ceramic Society (In press)

Y. M. Kim, M. Yoon, I-W. Park, Y. J. Park, J. H. you, “Synthesis and magnetic properties of Zn₁₋ₓMnₓO films prepared by sol-gel method”, Solid State Communications (In Press)

S. W. Lim, D. K. Hwang, J. M. Myoung, “Observation of optical properties related to room temperature ferromagnetism in co sputtered Zn₁₋ₓCoₓO thin films”, Solid State Communications, Vol. 125 (2003) 231-235

N. Ohashi, Y. Terada, T. Ohgaki, S. Tanaka, T. Tsurumi, O. Fukunaga, H. Haneda and J. Tanaka, “Synthesis of ZnO bicrystals doped with Co or Mn and their properties”, Japanese Journal of Applied Physics, Vol. 38, (1999) 5028-5032

S. J. Pearton, C. R. Abernathy, D. P. Norton, A. F. Hebard, Y. D. Park, L. A. Boatner and J. D. Budai, “Advances in wide bandgap materials for semiconductor spintronics”, Materials Science and Engineering R Vol. 40 (2003) 137-168

D. J. Qiu, H. Z. Wu, A. M. Feng, Y. F. Lao, N. B. Chen and T. N. Xu, “Annealing effects on the microstructure and photoluminescence properties of Ni doped ZnO films”, Applied Surface Science (In Press)

A. Y. Polyakov, A. V. Govorkov, N. B. Smirnov, N. V. Pashkova, S. J. Pearton, M. E. Overberg, C. R. Abernathy, D. P. Norton, J. M. Zavada and R. G. Wilson, “Properties of Mn and Co implanted ZnO crystals”. Solid State Electronics Vol. 47 (2003) 1523-1531

H. Saeki, H. Tabata and T. Kawai, “Magnetic and electric properties of vanadium doped ZnO films”, Solid State Communications Vol. 120 (2001) 439-443

K. Sato and H. K. Yoshida, “Material design for transparent ferromagnets with ZnO-based magnetic semiconductors”, Japanese Journal of Applied Physics, Vol. 39 (2000) K555-558

K. Sato, H. K. Yoshida, “Ferromagnetism in a transition metal atom doped ZnO”, Physica E Vol. 10 (2001) 251-255

K. Sato, H. K. Yoshida, “Electronic structure and ferromagnetism of transition metal impurity doped zinc oxide”, Physics B, Vol. 308-310 (2001) 904-907

I. Satoh and T. Kobayashi, “Magnetic and optical properties of novel magnetic semiconductor Cr-doped ZnO and its application to all oxide p-i-n diode”, Applied Surface Science, Vol. 216 (2003) 603-606

P. Sharma, A. Gupta, K. V. Rao, F. J. Owens, R. Sharma, R. Ahuja, J. M. O. Guillen, B. Johansson and G. A. Gehring, “Ferromagnetism above room temperature in bulk and transparent thin films of Mn-doped ZnO”, Nature Materials Vol. 2 (2003) 673-677

N. A. Theodoropoulou, A. F. hebard, D. P. Norton, J. D. Budai, L. A. boatner, J. S. Lee, Z. G. Khim, Y. D. park, M. E. Overberg, S. J. pearton and R. G. Wilson, “Ferromagnetism in Co and Mn doped ZnO”, Solid State Electronics Vol 47 (2003) 231-2235

A. Tiwari, C. Jin, A. Kvit, D. Kumar, J. F. Muth, J. Narayan, “Structural, optical and magnetic properties of diluted magnetic semiconducting Zn₁₋ₓMnₓO films”, Solid State Communications, Vol. 121 (2002) 371-374

K. Ueda, H. Tabata and T. Kawai, “Magnetic and electric properties of transition-metal doped ZnO films”, Applied Physics Letters Vol. 79 (2001) 988-990

T. Wakanao, N. Fujimura, Y. Morinaga, A. Abe, A. Ashida and T. Ito, “Magnetic and magneto transport properties of ZnO:Ni films”, Physica E, Vol 10 (2001) 260-264

M. Zhang, L. M. Cao, F. F. Xu, Y. Bando and W. K. Wang, “Structural properties of magnetron sputtered ZnO films with incorporated iron”, Thin Solid Films, vol. 406 (2002) 40-45

That which is claimed:

1. An article comprising:
a diluted magnetic semiconducting ZnO bulk single crystal.

2. An article as claimed in claim 1 wherein the crystal is doped with a 3d transition metal, a rare earth lanthanide, or both, to obtain magnetic properties.

3. The article in claim 1 wherein the crystal comprises dopant from a 3d transition metal that is one or more of Fe, Co, V, Ni, Mn, Cr, Sc, a rare earth lanthanide that is one or more of La, Ce, Pr, Nd, Pm, Sm, Eu, Gd, Tb, Dy, Ho, Er, Tm, Yb, Lu, or both.

4. The article as claimed in claim 1 wherein the crystal is grown by high pressure Bridgmann melt growth.

5. The article in claim 1 wherein the crystal comprises a substrate, defined as a bulk single crystal grown, cut, and processed to a specified thickness.

6. An article as claimed in claim 1 wherein the crystal is grown by Metalorganic Chemical Vapor Deposition (MOCVD).

7. An article as claimed in claim 1 wherein the crystal is grown using organic precursors.

8. An article as claimed in claim 1 wherein the crystal exhibits ferromagnetism and has a Curie temperature above 275 K.

9. An article as claimed in claim 1 wherein the crystal has a formula Zn₁₋ₓTEₓO wherein TE comprises a 3d transition element, a rare earth lanthanide, or both, and wherein the value of X is more than 0 but less than 40 at %.

10. A method comprising the step of:
growing a diluted magnetic semiconducting ZnO thin film crystal.

11. A method as claimed in claim 12 wherein the crystal is grown by doping with a 3d transition metal, a rare earth lanthanide, or both, to obtain magnetic properties.

12. A method as claimed in claim 12 wherein the crystal is grown to include a dopant comprising a 3d transition metals including Fe, CO, V, Ni, Mn, Cr, Sc, a rare earth lanthanide including La, Ce, Pr, Nd, Pm, Sm, Eu, Gd, Tb, Dy, Ho, Er, Tm, Yb, Lu, or both.

13. A method as claimed in claim 12 wherein the crystal is grown as a substrate, the method further comprising the steps of cutting and processing the substrate to a specified thickness.

14. An article as claimed in claim 12 wherein the crystal is grown by Metalorganic Chemical Vapor Deposition (MOCVD).

15. A method as claimed in claim 12 wherein the crystal is grown using organic precursors.

16. A method as claimed in claim 12 wherein the crystal is grown to exhibit ferromagnetism and has Curie temperature above 275 K.

17. A method as claimed in claim 12 wherein the crystal grown has a formula Zn₁₋ₓTEₓO wherein TE is a 3d transition element, a rare earth lanthanide, or both, and wherein the value of X is more than 0 but less than 40 at %.
